(19) United States
(12) Patent Application Publication
(10) Pub. No.: US 2002/0105959 A1
(43) Pub. Date: Aug. 8, 2002

(54) Multi-language broadcast system

(76) Inventor: Jeremy S. Laurin, Kingston (CA)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/778,850

(22) Filed: Feb. 8, 2001

(51) Int. Cl. H04J 3/26

(52) U.S. Cl. 370/432; 370/321

(57) ABSTRACT

The present invention comprises of a computer and multi-channel wireless rf transmission system for transmitting audio information to a large area audience. The system includes digitally sampled audio presentations recorded in many varied and different languages that are stored in memory locations and recalled by the main computer program for broadcasting. Each individual language is assigned to a separate audio channel. A multi-channel multiplexer is interfaced with the computer to direct each of the individual audio channels to a transmitter. Each transmitter is assigned a specific frequency or time signature for transmission of the audio signal over an antenna. A multi-channel receiver can be tuned to the frequency or time signature of the transmitter to receive any of the transmitted audio signals.

### FIELD OF THE INVENTION

The present invention relates generally to tour and large area broadcast systems and, more particularly, to simultaneous multi-language broadcast over a wireless medium for the purpose of receiving the broadcasted signal in the desired language. The primary application is for public facilities such as auditoriums, class-rooms, places-of-worship, courtrooms, guided and un-guided tours such as boats, buses, museums and walking tours whereby the user can listen to a portable radio tuned to a channel covering the language of choice.

### BACKGROUND OF THE INVENTION

Public facilities and attractions draw the attention of individuals from all over the world. Guided and un-guided tours offer the tourist or visitor an opportunity to tour of visit the facility of location. For many, the tour guide presents the information in the language most common to that geographic area or facility. This limits the amount of actual information many visitors derive from the tour due to language limitations or cultural differences. Some tours provide more than one guide with the ability to speak in different languages.

Many tourists or visitors receive varied amounts of actual information about a tour or site depending on their understanding of the language of the tour guide. For many it is frustrating or futile to listen because of the limited understanding of the language or ability to hear in an environmentally noisy area.

One way of presenting the information comprises the serial output of a number of different languages. This is not satisfactory due to the time necessary and furthermore due to the fact that many find it annoying listening to a large amount of information in foreign languages.

Another way of presenting the information comprises the parallel output from several different replay and transmission devices, where each device represents a single language. This is a solution that will require a significant amount of equipment and hence represents a both cumbersome and costly solution.

### SUMMARY OF THE INVENTION

It is the object of the present invention to provide a pre-programmed multi-language experience for the visitor or tourist in an environment that is rewarding and informative and which at the same time requires a reduced amount of equipment than hitherto known.

The proposed system extends the benefit of the tour presentation to the visitor by providing them with a pre-programmed presentation in their language. The visitor wears a portable radio that receives the transmission from all language broadcast channels and selects which of the channels to listen. The pre-programmed information is arranged as digital files that can be called and sent to the transmitter for broadcast. Each digital file contains the tour presentation in a specific language. The computer is programmed to track the tour path or events and will broadcast the information for a given or specific site at the command of the tour operator or automatically when receiving external information such as a gps signal or switch signal indicating that it is ready to transmit the information about that specific site. The computer program selects the files containing the site information in the varied languages and broadcasts them over individual radio channels or time-slots.

The system as described uses pre-programmed presentations recorded and digitized for use by a computer. The computer program calls the appropriate languages describing the site or event at a time that is synchronized with the actual site or event. The multi-language files are output to a de-multiplexer that separates each language into an individual channel for broadcast over a wireless transmitter. The tourist or visitor receives the information via a wireless receiver, tuned to their language-channel, and listens to the presentation via a headset.

### BRIEF DESCRIPTION OF THE DRAWING

FIG. 1 is a schematic diagram depicting the elements of a preferred embodiment of the invention.

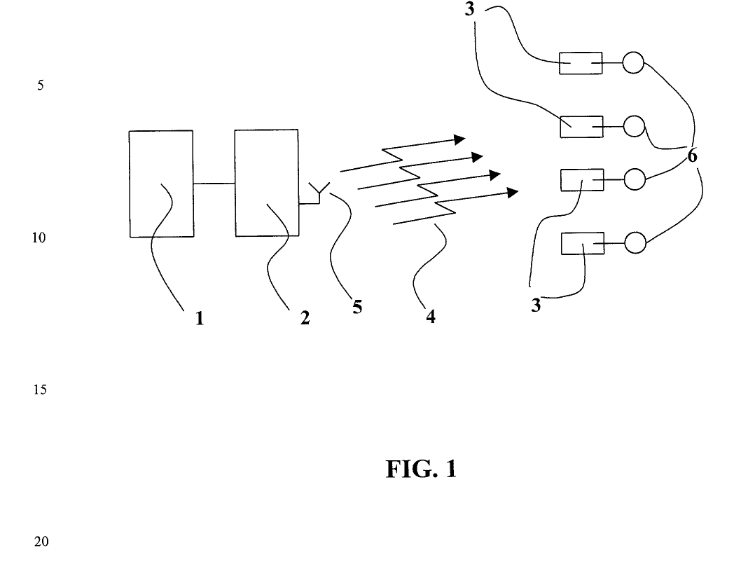

### DESCRIPTION OF A PREFERRED EMBODIMENT

A computer 1 programmed to respond to switch, voice, external signals for selection of specific information, pre-recorded and digitized into data files, that outputs the selected files to a wireless transmitter. The data files may be transmitted via a multi-plexed digital format using such RF modulation technologies as spread-spectrum frequency hoping, Time division multiple access, Code division multiple access, standard analog channels using different forms of modulation such as frequency modulation, time-domain modulation or amplitude modulation. The wireless transmitter 2 feeds one or multiple antennas 5 covering the area or desired range. The antenna 5 may also consist of high-loss coax, ground-plane, vertical or horizontal dipoles. The wireless receivers 3 contain the circuits necessary to receive the transmitted signals 4 and to de-modulate the signal into audio information that is amplified and output to a headsetspeaker 6. Contained in the receiver is a selector device adapted for selecting the desired channel and hereby the desired language.

1. A multi-channel transmission and receiving system for the broadcast of pre-programmed information in varied languages, where each pre-programmed language is digitized and saved as a data file that is called by a main program in a computer when required, where the main program is programmed to respond to external or time events that determine which data files are to be used and output to a digital to analog converter and/or de-multiplexer, where each analog channel is sent to a transmitter tuned to a channel specific for the use of the analog signal, where transmitter outputs are combined via a tuned series of filters to an antenna, where the receiver is portable, and designed to receive the transmitted frequencies and comprises a channel select switch in the receiver determines which of the transmitter frequencies to receive, hereby determining which language to receive.

2. A multi-channel transmission system as described in item 1 whereby the computer is controlled by specific GPS or location data that guides the computer program to select the appropriate files for that specific geographic zone or site.

3. A multi-channel transmission system as described in item 1 whereby the data files are output to the computer port as serial data, whereby the serial data is re-programmed via means of digital signal processing and transmitted as Time Division Multiple Access via a spread-spectrum frequency hoping transmitter and where the receiver is capable of receiving the wireless signal and de-coding the appropriate channel via a selector switch.
